(19) United States
(12) Patent Application Publication
(10) Pub. No.: US 2024/0184902 A1
(43) Pub. Date: Jun. 6, 2024

(54) Air-Gapped Cryptographic Communication System

(71) Applicants: Cansu Deniz Yetkin, Dallas, TX (US); Oguz Yetkin, Dallas, TX (US)

(72) Inventors: Cansu Deniz Yetkin, Dallas, TX (US); Oguz Yetkin, Dallas, TX (US)

(21) Appl. No.: 18/419,349

(22) Filed: Jan. 22, 2024

Related U.S. Application Data
(60) Provisional application No. 63/480,987, filed on Jan. 22, 2023.

(51) Int. Cl. G06F 21/60; G06F 21/36

(52) U.S. Cl. CPC G06F 21/606; G06F 21/36; G06F 21/602

(57) ABSTRACT

The present invention is a device which enables two parties to communicate secretly through the use of One Time Pad cryptography, the only cryptosystem known to be mathematically secure. The invention implements an air-gapped messaging system by treating existing smartphones capable of sending photographs as insecure channels. It allows a user to encrypt a message and display the ciphertext as human readable text or a 2D Barcode (such as a QR Code) on a screen, and transmit the message to a second party using a secondary communication device such as a smartphone, allowing the second party to decrypt the message by means of a camera. The recommended embodiment of the device is an air-gapped portable hardware system with a camera, display screen, and keyboard or touch screen input capabilities, but other embodiments (such as one which uses sound waves instead of photographs) are presented.

### PRIOR ART

Prior art in cryptographic communication systems encompasses public key cryptography in which a secret key exchange is not required, as well as shared key cryptography. The One Time Pad has been around since 1882 and is an implementation of the well-known Vigenere Cipher in which the message to be encrypted and the key are of the same length. One Time Pad cryptosystems have been proven secure provided that: 1) only two copies of the key exist, 2) the key is truly random, and 3) the key is destroyed as soon as it is used. One Time Pad based cryptosystems have only seen limited use due to the difficulty of exchanging large keys. The present invention takes advantage of modern information-dense storage systems and the prevalence of cameras (and microphones) on smartphones in order to implement an air-gapped cryptosystem rendering the use of One Time Pad cryptography practical.

### BACKGROUND OF THE INVENTION

The state-of-the-art two-way cryptographic messaging systems include cellular phones using the Short Message System (SMS), smartphone or Personal Digital Assistant (PDA) systems, and personal computers. Encryption is generally achieved via the use of public key cryptography, but other cryptosystems, such as the use of One Time Pad systems (OTP), have been proposed and implemented.

Despite the cryptographic security afforded by state-of-the-art algorithms, there remains an ever-present danger of device compromise at the application or operating system level, allowing a third party to intercept the messages. Network (Internet or otherwise) connectivity, which is ubiquitous in such devices, also presents a vulnerability. Furthermore, the current practice requires these devices to constantly download and install updates, potentially introducing new vulnerabilities or attack vectors inserted by adversaries, who may have obtained control over the update servers or compromised the source code of the device operating system.

The concept of “air gapping” devices involves leaving computer systems intentionally unconnected to the Internet and other computer networks. In such instances, using these devices to send and receive encrypted messages becomes impractical, requiring the sender to print out and the recipient to manually enter the encrypted message in order to obtain the decrypted plain text.

### SUMMARY OF THE INVENTION

Embodiments of the present invention provide methods for two air-gapped devices (Device A and Device B) to communicate with each other by the use of a keyboard, a display element such as a monitor, and a camera. The system relies on the two parties (Party A and Party B) having access to two other devices, such as smartphones, which are capable of capturing and transmitting images, albeit not necessarily securely (Phone A and Phone B). In order to use the system, Party A uses the keyboard on Device A to type a message to be encrypted, causing Device A to display the encrypted message using either a human-readable alphabet or a two dimensional barcode. After this, Party A uses Phone A to transmit the image of the screen to Party B. Party B, upon receiving the image of the message on Phone B, uses the camera on Device B to capture an image of the encrypted message. Device B translates the image to ciphertext using a computer vision algorithm, decrypts the message, and shows the decrypted plaintext to Party B.

### BRIEF DESCRIPTION OF DRAWINGS

The following figures are included to demonstrate certain aspects of the present invention and

should not be used to limit or define the invention.

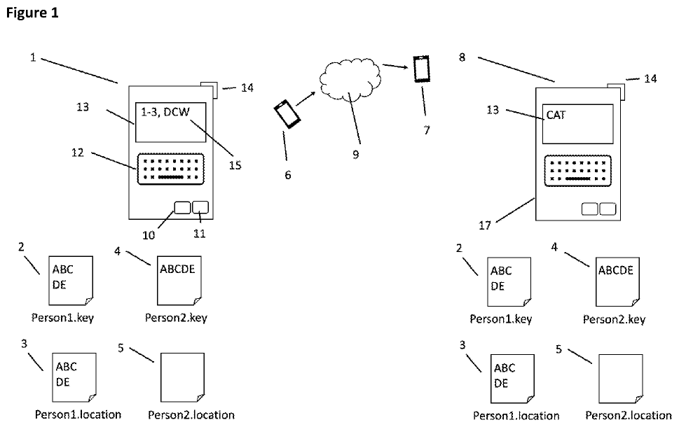

FIG. 1 is a schematic summary of the devices and the communication system. FIG. 1 shows one possible embodiment of the device, illustrating how two participants, Party A and Party B, might communicate.
1. First Device (Device A).
2. File containing a random key, at least as long as the message to be sent to Party A (Person1.key).
3. File containing the last location used in the key (Person1.location).
4. File containing a random key, at least as long as the message to be sent to Party B (Person2.key).
5. File containing the last location of the key used for sending a message to Party B (Person2.location).
6. Phone A, a secondary (possibly insecure) communication device (such as a smartphone) capable of sending photographs, to be used by Party A.
7. Phone B, a secondary (possibly insecure) communication device (such as a smartphone) capable of sending photographs, to be used by Party B.
8. A second device (Device B), an embodiment of the present invention, to be used by Party B.
9. A communication network (possibly insecure), such as the Internet.
10. Encrypt Button
11. Decrypt Button
12. Keyboard
13. Display Screen
14. Camera
15. Displayed Ciphertext, two dimensional barcode, or QR Code
17. Portable storage device (such as an SD card, USB thumb drive or similar) containing the folder and files to be used to communicate with one or more individuals.

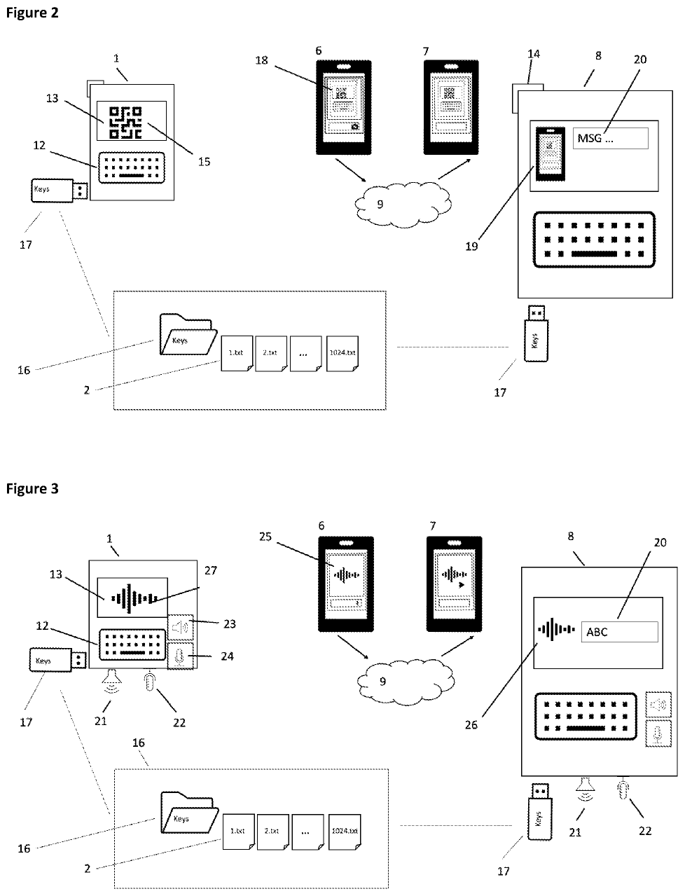

FIG. 2 Is a schematic summary of another embodiment of the device and communication system, illustrating how two participants, Party A and Party B, might communicate.
1. First Device (Device A)
2. Files containing random keys, each at least as long as the message to be exchanged between the parties, with each party having a copy of each key (1.txt, 2.txt, etc.)
6. Phone A, a secondary (possibly insecure) communication device (such as a smartphone) capable of sending photographs, to be used by Party A
7. Phone B, a secondary (possibly insecure) communication device (such as a smartphone), capable of sending photographs, to be used by Party B
8. Device B, an embodiment of the present invention, to be used by Party B.
9. A communication network (possibly insecure), such as the Internet
12. Keyboard
13. Display Screen
14. Camera
15. Displayed Ciphertext or 2-dimensional Barcode
16. Folder containing a multiplicity of files (1.txt 2.txt etc.), to be used as One Time Pad keys
17. Portable storage device (such as an SD card, USB thumb drive or similar) containing the folder and files to be used to communicate with one or more individuals
18. Photo of Device A
19. Photo of Device B
20. Displayed Decrypted Message

FIG. 3 is a summary of another embodiment of the invention which uses sound instead of photographs to bridge the air gap, illustrating how two participants, Party A and Party B, might communicate.
1. First Device (Device A)
2. Files containing random keys, each at least as long as the message to be exchanged between the parties, with each party having a copy of each key (1.txt, 2.txt, etc.) to be used as One Time Pad keys
6. Phone A, a secondary (possibly insecure) communication device (such as a smartphone), capable of sending photographs, to be used by Party A
7. Phone B, a secondary (possibly insecure) communication device (such as a smartphone), capable of sending photographs, to be used by Party B
8. Device B, an embodiment of the present invention, to be used by Party B.
9. A communication network (possibly insecure), such as the Internet
12. Keyboard
13. Display Screen
16. Folder containing a multiplicity of files (1.txt 2.txt etc.), to be used as One Time Pad keys
17. Storage device (such as an SD card, USB thumb drive or similar) containing the folder and files to be used to communicate with one or more individuals
20. Displayed decrypted message
21. Speaker
22. Microphone
23. Speaker Button
24. Microphone Button
25. Audio Recording from Device A, recorded by Phone A
26. Audio Recording on Device B, made from Phone B

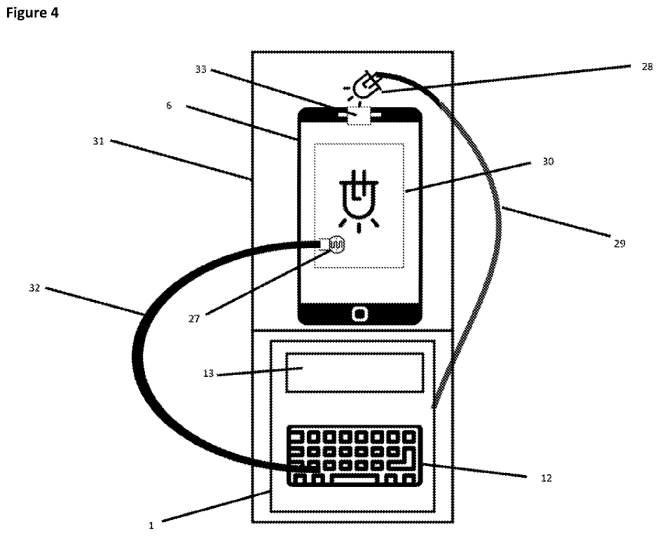

FIG. 4 is a schematic summary of a different embodiment of the device, which uses a single LED and a single light sensor, and videos recorded and sent by the smartphone devices to bridge the air gap.
1. Device A
6. Phone A
12. Keyboard
13. Screen
14. Camera
27. Light Sensor (e.g., Phototransistor, Light Dependent Resistor, or the like)
28. LED or other light source
29. Flexible LED Cable
30. Video of blinking LED sent from Device B
31. Cradle for holding Device A and Phone A
32. Flexible Light Sensor Cable
33. Camera attached to Device A

### DETAILED DESCRIPTION OF THE INVENTION

FIG. 1 describes a possible embodiment of the invention. In this embodiment, there is provided a device (1) (Device A) comprising a keyboard (12), a display screen (13), a camera (14), an encrypt button (10) a decrypt button (11) and a computer or microcontroller as well as a storage element (17) (such as a hard drive or an SD card) on which is recorded a string of random numbers whose length exceeds the length of the intended message, serving as a cryptographic key. There is also provided a second device (8) (Device B), of the same configuration, and possessing an identical cryptographic key.

In order to operate the system, the sender (Party A) enters a message using the provided keyboard on the device (Device A). The computer or microcontroller picks a random offset location in the key and creates a message consisting of key_location, message_length, and ciphertext (plaintext encoded with the elements of the key, starting at key_location). The ciphertext is then encoded into an image, either using human readable letters or a two dimensional barcode system (such as a QR Code), and displayed on the screen.

The sender (Party A) then transmits the encoded message to the recipient using a less secure secondary system, such as a smartphone with a messaging app (Phone A).

The recipient (Party B), upon receiving the image on his/her less secure device (Phone B), uses the camera provided by Device B in order to capture the image displayed by Phone B.

In FIG. 2 is represented another possible embodiment of the device. In this embodiment, Party A enters the secret message on Device A (1) using the keyboard (12). Device A encrypts the message using one of the key files (2) stored on the portable storage device (17) in the key folder (16) and displays the file name along with the encoded ciphertext on the display screen (13) either as human readable text, a two dimensional barcode such as a QR code (15) or another format which can be photographed with a camera. Upon encoding, Device A deletes the key (2). Party A then uses a possibly insecure communication device, Phone A (6) to take a photograph (18) of Device A including the displayed message. Party A then sends the photograph (18) to Phone B (7) through the Internet or other network (9) using an existing messaging application capable of transmitting photograph. Upon receipt of the photograph, Party B uses Device B (8) to take a photograph (19) of Phone B (7). Device B then uses computer vision algorithms to recognize either the human readable text or the two dimensional barcode (such as a QR code) to decode the file name and the encoded characters. Device B extracts the unencrypted filename. It then accesses the file (2) on the portable storage device (17) and decrypts the message. It displays the message (20) on the screen, and deletes the key file, destroying the last remaining copy of the key. The keys can also reside on the internal storage of the device. Ideally, the keys are kept offline and disconnected from the device when not in use. For the device to be fully effective as a 100% secure communication medium, both devices must be offline and communicate only through their cameras and screens, allowing the user to enter messages only through the keyboard.

The keys (2) are stored in a portable memory device such as a USB thumb drive (flash memory) device and are written simultaneously to both keys at the time of key creation. The computer code enabling the embodiment described in FIG. 2 is given in Listing 1 through Listing 9. While this code is implemented using the UNIX system on a Raspberry Pi computer in the Python and BASH scripting languages, it should be kept in mind that many such embodiments of the invention are possible using alternative systems, languages, and hardware.

In FIG. 3 is described an alternate embodiment of the device using sound waves transmitted by the possibly insecure Phone A and Phone B devices instread of photographs. The State of the Art contains many possible methods to encode data into sound, including the International Telegraphic Union (ITU) modem standards such as V.13, V.22, V.90, etc. as well as the Dual Tone Multi Frequency (DTMF) standard for easy encoding of numbers into sound waves. Specifically, every byte (8 bits) can be encoded into two consecutive DTMF sounds (0,1,2,3,4,5,6,7,8,9,#,*,A,B,C,D), each capable of representing 4 bits of data. The topic of encoding a string of bytes as sound waves will be familiar to practitioners ordinarily skilled in the art. In this embodiment, Party A enters the message on Device A (1) using the keyboard (12). After this, Party A activates the sound recording feature on Phone A (6) and presses the speaker button (23) on Device A. Device A encrypts the message using one of the key files (2) stored on the portable storage device (17) in the key folder (16). After this, Device A creates an audio file representing the unencrypted file name and the encrypted message, and plays this audio file back through the speaker (21).

Party A then sends the recording on Phone A (25) to Phone B (7) through the Internet or other network (9) using an existing messaging application capable of transmitting audio files. Upon receipt of the audio recording, Party B presses the microphone button (24) on Device B to start an audio recording. Party B then starts playing back the audio received by Phone B (7), creating a new recording (26) on Device B. Device B then decodes the encoded audio and extracts the unencrypted filename and the bytes representing the encrypted message.

It then accesses the file (2) on the portable storage device (17) and decrypts the message. It displays the message on the screen, and deletes the key file, destroying the last remaining copy of the key.

In FIG. 4 is presented another embodiment of the device, which uses the video recording and sending features modern smartphones in order to bypass the need for a screen, allowing for a much more compact embodiment of the device to be created. It must be understood that this device still uses the same principle of exploiting the camera on a modern smart phone to transmit encoded messages to the other device.

In this embodiment, Device A (1) is kept in proximity to Phone A (6), optionally with the use of a cradle (31). A light source (LED or otherwise) is affixed on a flexible LED cable (29) and is placed on top of the camera (33) attached to Device A (6), not necessarily in focus. There is also a light sensor (including, but not limited to a Light Dependent Resistor, phototransistor, or photodiode), affixed to a light detector cable (32) pointing to the screen (13) of the cable. In this embodiment, Party A enters the message to be encoded using the keyboard (12) and then starts a video recording on Phone A, with the LED (28) positioned in view of the Device A camera (32) using the flexible LED cable (29). The user then presses the encode button on Device A. Device A encodes the message using the stored One Time Pad key and deletes the key. Device A then encodes the unencrypted filename and the encrypted message as light pulses and causes the LED (28) to flash in a way which represents the filename and message. Many methods exist in the state of the art to encode bytes as light pulses. The rate of encoding must be at most half the frame rate of the camera. Party A then uses the video sending feature of an existing application on Phone A to send the recording to Party B.

Upon receiving the message, Party B places the light sensor (27) using the flexible light sensor cable (32) on Device B's screen, in such a way that it will see the light from the played back video. Party B then presses the decode button on Device B and starts playing back the video. Device B records the light pulses on the video being played back on the screen (30). Device B decodes the message and displays it on the device screen (13).

The following software listings give an example of a possible embodiment of the system detailed in FIG. 2 using the BASH scripting language and the Python programming language.

Listing 1: Random255.py, a script used to generate
255 random numbers to be used as One Time Pads

```
import random
import sys
import binascii
from datetime import datetime
random.seed(datetime.now( ).timestamp( ))
result=“”
for i in range(0,255):
  randval = random.randint(0,sys.maxsize)
  randstr=str(randval)
  result+=randstr
print(result)
```

Listing 2: Generate_randoms.sh, a
BASH script used to create random numbers

for i in {1..1024}
do
python3 ../random255.py >$i.txt
done

Listing 3: otp_encode.sh, a BASH script to be run on a Raspberry
Pi or similar device running Linux, to encode and display
a secret message as a two dimensional barcode (QR Code)

rm qrout.png
./get_input.py > otp_input.txt
ENCODED_INPUT=$(./otp_crypto2.py otp_input.txt)
#Delete the file after encryption
#Fill the file with different data as insurance against undelete programs and utilities
echo xxx > otp_input.txt
#Destroy the file
rm otp_input.txt
./qrencode.py $ENCODED_INPUT qrout.png
open qrout.png

Listing 4: otp_crypto2.py a Python program that
implements the main logic of the system which
serves as an embodiment of the present invention

```
#!/usr/bin/python
# -*- coding: utf-8 -*-
import binascii
import os
import random
sifre_dir = ‘keys’
mesaj=“a ”
parola=“a”
def sifre_yarat(mesaj,parola):
  mesaj_uzunlugu = len(mesaj)
  parola_uzunlugu = len(parola)
  sifreli_mesaj=“”
  for harf_sayisi in range(0,mesaj_uzunlugu):
    mesaj_harf = mesaj[harf_sayisi]
    parola_harf = parola[harf_sayisi%parola_uzunlugu]
    yeni_harf = chr( (ord(mesaj_harf) + ord(parola_harf))%65535)
    sifreli_mesaj = sifreli_mesaj+yeni_harf
  return sifreli_mesaj
def sifre_coz(mesaj,parola):
  mesaj_uzunlugu = len(mesaj)
  parola_uzunlugu = len(parola)
  cozulmus_mesaj=“”
  for harf_sayisi in range(0,mesaj_uzunlugu):
    mesaj_harf = mesaj[harf_sayisi]
    parola_harf = parola[harf_sayisi%parola_uzunlugu]
    yeni_harf = chr( (ord(mesaj_harf) − ord(parola_harf))%65535)
    cozulmus_mesaj = cozulmus_mesaj+yeni_harf
  return cozulmus_mesaj
import sys
def print_usage( ):
  print(“use:%s [−d message] file”%(sys.argv[0]))
if_name_ == “_main_”:
  if len(sys.argv) < 2:
    print_usage( )
  elif(sys.argv[1] == “−d”):
    if len(sys.argv) < 3:
      print_usage( )
    else:
      #sifre cozuyoruz
      anahtar_dosya_ve_mesaj = sys.argv[2]
      #print(anahtar_dosya_ve_mesaj)
      anahtar_dosya=anahtar_dosya_ve_mesaj.split(‘_’)[0]
      hex_mesaj=anahtar_dosya_ve_mesaj.split(‘_’)[1]
      #print(“hex_mesaj:”+hex_mesaj)
      mesaj = binascii.unhexlify(hex_mesaj).decode(‘utf-8’)
      f=open(sifre_dir+“/”+anahtar_dosya)
      anahtar=str(f.read( ))
      #print(anahtar)
      f.close( )
##  print(“mesaj: ”+mesaj)
##  print(“anahtar: ”+anahtar)
      cozulmus_mesaj = sifre_coz(mesaj,anahtar)
      #cozulmus_mesaj =
      sifre_coz(str(binascii.a2b_base64(mesaj)),parola)
      print(cozulmus_mesaj)
  else:
    #yalnizca sifreli mesaj yaratiyoruz
    msgfile = open(sys.argv[1])
    mesaj=msgfile.read( )
    msgfile.close( )
    #print(“mesaj: ”+mesaj)
    #tek kullanimlik serit (One Time Pad) dosyasini secelim
    dosyalar=os.listdir(sifre_dir)
    anahtar_dosya=random.choice(dosyalar)
    f=open(sifre_dir+“/”+anahtar_dosya)
    anahtar=f.read( )
    f.close( )
    sifreli_mesaj = sifre_yarat(mesaj,anahtar)
    #print(binascii.b2a_base64(bytes(sifreli_mesaj,‘utf-8’))),
    sifreli_mesaj_hex = binascii.hexlify(sifreli_mesaj.encode(‘utf-8’))
    print(anahtar_dosya+“_”+sifreli_mesaj_hex.decode( ))
    #print(str(binascii.hexlify(sifreli_mesaj.encode(‘utf-8’))))
```

Listing 5: get_input.py a utility script to interactively obtain
input from the user, referenced from the web site in the comments

```
#!/usr/bin/python
#REFERENCE: https://stackoverflow.com/questions/38725442/how-to-use-tkinter-entry-like-raw-input
import tkinter as tk
w = 800 # width for the Tk root
h = 650 # height for the Tk root
#https://stackoverflow.com/questions/35817/how-to-escape-os-system-calls
def sh_escape(s):
  return s.replace(“(“,”\\(”).replace(“)“,”\\)”).replace(“ “,”\\ ”)
def gui_input(prompt):
  root = tk.Tk( )
  w = 600 # width for the Tk root
  h = 100 # height for the Tk root
  # get screen width and height
  ws = root.winfo_screenwidth( ) # width of the screen
  hs = root.winfo_screenheight( ) # height of the screen
  x=20
  y=20
# set the dimensions of the screen
# and where it is placed
  #print(‘% dx % d+% d+% d’ % (w, h, x,y))
  root.geometry(‘% dx % d+% d+% d’ % (w, h, x, y))
  # this will contain the entered string, and will
  # still exist after the window is destroyed
  var = tk.StringVar( )
  # create the GUI
  label = tk.Label(root, text=prompt)
  entry = tk.Entry(root, textvariable=var)
  label.pack(side=“left”, padx=(20, 0), pady=20)
  entry.pack(side=“right”, fill=“x”, padx=(0, 20), pady=20, expand=True)
  # Let the user press the return key to destroy the gui
  entry.bind(“<Return>”, lambda event: root.destroy( ))
  # this will block until the window is destroyed
  root.mainloop( )
  # after the window has been destroyed, we can't access
  # the entry widget, but we_can_ access the associated
  # variable
  value = var.get( )
  return value
mesaj = gui_input(“Sifrelenecek Mesaj”).encode(‘utf-8’)
```

Listing 6: otp_decode.sh the BASH shell script which implements
the main logic of decoding a message from a smart phone bearing
a QR code when it is shown to the computer camera

./capture_photo2.py
./otp_crypto.py −d $(./qrdecode.py qr.jpg) >otp_output.txt
./messagebox1.py “$(cat otp_output.txt)”

Listing 7: Capture_photo2.py a utility program written
in the Python language to capture a photo from a camera,
in this case using the OpenCV computer vision software
library, which is well known in the state of the art

```
#!/usr/bin/python
# import the opencv library
import cv2
# define a video capture object
vid = cv2.VideoCapture(0)
frames=120 #frame countdown
while(True):
    # Capture the video frame
    # by frame
    ret, frame = vid.read( )
    if frames > 0:
  cv2.putText(frame,
      “QR kodunu gosterin: ”+str(frames),
      (50, 50),
      cv2.FONT_HERSHEY_SIMPLEX, 1,
      (0, 255, 255),
      2,
      cv2.LINE_4)
    frames = frames − 1
    # Display the resulting frame
    cv2.imshow(‘frame’, frame)
    if frames < 0:
  cv2.imwrite(‘qr.jpg’,frame)
  break
    # the ‘q’ button is set as the
    # quitting button you may use any
    # desired button of your choice
    if cv2.waitKey(1) & 0xFF == ord(‘q’):
        break
# After the loop release the cap object
vid.release( )
# Destroy all the windows
cv2.destroyAllWindows( )
```

Listing 8: messagebox1.py a program written in the Python
language to display the decrypted message to the user,
referenced from online sources, (Reference in code)

```
#!/usr/bin/python3
#REFERENCE: https://www.geeksforgeeks.org/python-tkinter-scrolledtext-widget/
import sys
import tkinter as tk
from tkinter import ttk
from tkinter import scrolledtext
# Creating tkinter main window
win = tk.Tk( )
win.title(“Air Gapped Communication Program”)
# Title Label
ttk.Label(win,
  text = “Secret Content”,
  font = (“Times New Roman”, 15),
  background = ‘green’,
  foreground = “white”).grid(column = 0,
    row = 0)
# Creating scrolled text
# area widget
text_area = scrolledtext.ScrolledText(win,
    wrap = tk.WORD,
    width = 40,
    height = 10,
    font = (“Times New Roman”,
      72))
mesaj=sys.argv[1]
mesaj.strip(‘\”’)
text_area.insert(tk.INSERT,mesaj)
text_area.grid(column = 0, pady = 10, padx = 10)
text_area.configure(state =‘disabled’)
# Placing cursor in the text area
text_area.focus( )
win.mainloop( )
```

Listing 9 otp_decode.sh a BASH shell script which
implements the main logic of decoding a message from
a 2D Barcode (QR Code) and destroying the used key

./capture_photo2.py
./otp_crypto.py −d $(./qrdecode.py qr.jpg) >otp_output.txt
./messagebox1.py “$(cat otp_output.txt)”
#Fill the file with different data, as an
insurance against “undelete” programs
echo xxx >otp_output.txt
#Now delete the file
rm otp_output.txt

1. A system comprising:
a. A method of entering a message to be encrypted
b. A method of writing to a storage device
c. A method of reading from a storage device
d. A microcontroller or a computer capable of encrypting and decrypting messages
e. A method of representing the ciphertext as either light pulses or as a 2D image
f. A method of acquiring light pulses or an image from a secondary device and extracting ciphertext from the representation.

2. A system comprising:
a. A method of entering a message to be encrypted
b. A method of writing to a portable storage device
c. A method of reading a portable storage device
d. A microcontroller or a computer capable of encrypting and decrypting messages
e. A method of emitting sound, such as through a loudspeaker
f. A microphone
g. A method of recording and decoding sound.
h. A means of encoding digital data as sound.

3. The system in claim 1 where the method of generating light pulses is an LED attached to the device and the system of acquiring light pulses is a single pixel light detector.

4. The system in claim 1 where the method of representing the ciphertext is a screen displaying human readable text.

5. The system in claim 1 where the method of representing the ciphertext is a 2 Dimensional Barcode.

6. The system in claim 1 where the method of acquiring ciphertext from an insecure device is a camera.

7. The system in claim 1 with a hardware-based random number generator, including but not limited to the use of noisy electronic circuits, drift in timer circuits, measurement of radiation, or the input of a digital number camera used to seed a pseudo-random number generator or record random numbers directly.

8. The system in claim 1 in which the message is entered via a keyboard, displayed on the screen as characters of a human alphabet, wherein the user transmits the image of the screen to a second party using a secondary communication device, and wherein the matching device is used to extract the ciphertext from the image of the communication device.

9. The system in claim 1 in which the message is entered via a keyboard, displayed on the screen as a two dimensional barcode, wherein the user transmits the image of the screen to a second party using a secondary communication device, and wherein the matching device is used to extract the ciphertext from the image of the communication device.

10. The system in claim 2 in which the message is entered via a keyboard, modulated as audible sound, wherein the user transmits the sound to a second party using a secondary communication device, and wherein the matching device is used to extract the ciphertext from the sound emitted by the secondary communication device.
